(19) United States
(12) Patent Application Publication
(10) Pub. No.: US 2009/0313901 A1
(43) Pub. Date: Dec. 24, 2009

(54) DOOR MOUNT FOR A SAFE

(75) Inventor: Brett Dunstan, Victoria (AU)

Correspondence Address: CHERNOFF, VILHAUER, MCCLUNG & STENZEL, LLP, 601 SW Second Avenue, Suite 1600, Portland, OR, 97204, US

(73) Assignee: LOKAWAY PTY. LTD., Hallam, Victoria (AU)

(21) Appl. No.: 11/993,201

(22) PCT Filed: Jul. 6, 2006
(86) PCT No.: PCT/AU2006/000983

§ 371 Date: Dec. 19, 2007

(30) Foreign Application Priority Data
Jul. 7, 2005 (AU) 2005903611

(51) Int. Cl. E05D 15/58

(52) U.S. Cl. 49/254

(57) ABSTRACT

A security safe of the swing and slide type has a pair of door hinges fixed to the door, a pair of frame hinges fixed to the frame and a pair of intermediate hinges by combined links which allow the door hinge to swing outside the plane of the door opening when the door is opened through 180°. Slide motion is imparted by a door handle and a reaction rod which acts against link.

### FIELD OF THE INVENTION

This invention concerns safes for valuables and guns.

### BACKGROUND OF THE INVENTION

In our co-pending application for Patent No. PCT/AU03/001321, we describe safes with two pairs of hinges, one set is mounted on the safe body and the other set is mounted on the door. The two sets of hinges are interconnected to create an offset motion whereby the door is free to both slide left and right and to swing open and closed.

The hinges are installed inside the door opening and the door width exceeds the door opening width. The swing and slide motion allows the door to slide first to clear the door opening and then to swing toward the person opening the safe giving access to the safe interior. The geometry of this arrangement permits the door to open say 90-110°. There are instances where ammunition is kept in the safe and it would be more visible if it could be stored on shelves on the inside face of the door in the manner of egg shelves inside the door of a refrigerator. It would be more convenient if the door were to open wider say up to 180° or even 270°.

### SUMMARY OF THE INVENTION

This invention provides a safe of the swing and slide type having a pair of door hinges fixed to the door, a pair of frame hinges attached to the frame and a pair of intermediate hinges fixed to both the door hinges and the frame hinges by links so that the hinge axes are all mutually parallel and the links allow the displacement of the door hinge to lie outside the plane of the door opening when the door is opened through 180°.

The door hinges may be connected to the intermediate hinges by a first link which allows the slide motion of the door. This link may be a pair of arms 5-25 mm long.

The frame hinges may be connected to the intermediate hinges by a second link and preferably this link is longer than the first link in order to give greater throw. It is this second link which allows rotation of the door and its sets of hinges into the space adjacent to the door opening, whereby the door is free to rotate through 180°. The second link may be a bar or angle member of sufficient width to space the door face from the body of the safe to permit the desired angle of swing. The width may be 50-70 mm.

The door sliding motion may be provided by a handle as described in our Patent No. PCT/AU03/001321 and the reaction rod may react against the second link instead of the rod or bar which connects the frame hinges.

### BRIEF DESCRIPTION OF THE DRAWINGS

One embodiment of the invention is now described with reference to the accompanying drawings, in which:

FIG. 1 is a sectional plan showing the door closed omitting the reaction bar.

FIG. 1A is as FIG. 1 indicating how door slide occurs.

FIG. 2 is a sectional plan showing the door half open omitting the reaction bar.

FIG. 3 is a section plan showing the door fully open and the position of the reaction bar.

FIG. 4 is a front view of part of the safe with the door in the position shown in FIG. 3.

### DETAILED DESCRIPTION WITH RESPECT TO THE DRAWINGS

The safe components are numbered as in PCT/AU03/001321 and extra components as occur in the embodiment described below are given numbers which follow on.

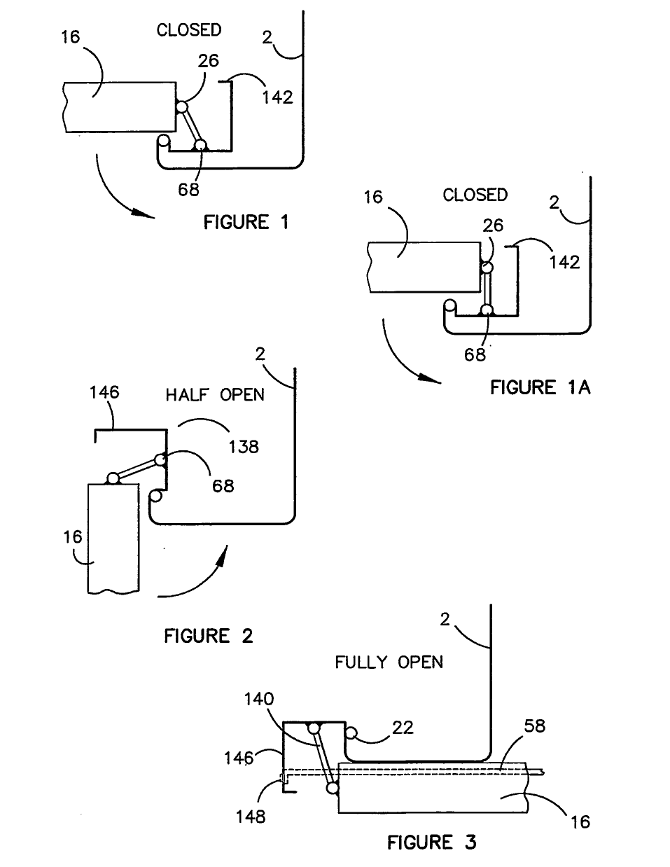

Referring now to FIGS. 1-4, the body 2 supports frame hinges 22 (one only shown) and these hinges in turn support L-section steel link 138 which extends substantially the full length of the door 16. Intermediate hinges 68 (only one shown) are welded to the face of the first leg of the link 20 mm from hinge 22. Door hinges 26 (one only shown) are welded to the edge of door 16. The door hinges are connected to the intermediate hinges by links 140 (one only shown). In this instance the links are steel spacer bars 20 mm long. The throw afforded by the combined links 138 and 140 allow the door to slide left and right in FIG. 1 and to swing open through 180° as shown in FIG. 3. It is still necessary to join the top and bottom intermediate hinges 68 through link so that the hinges 68 and door hinge 26 act as a unitary assembly eliminating waggle in the door. The L-section link is stiffened by flange 142.

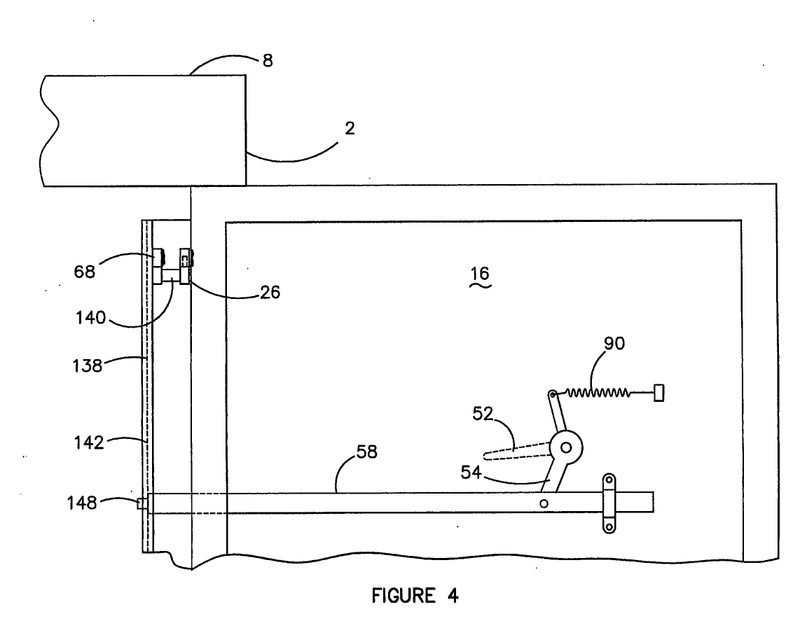

The slide motion of the door requires modification in that in PCT/AU03/001321 the rod connecting the top and bottom hinges is not in the same position and is not available as a reaction surface against which reaction bar 58 can abut. In FIGS. 3 and 4 reaction bar 58 passes through an aperture 144 in the door edge and abuts the second leg 146 of the L-section link 138 where it is fixed by a bolt 148. Rotation of the handle causes the door to slide between the positions shown in FIGS. 1 and 1a.

We have found the advantages of the above embodiment to be:
1. Wider door opening while retaining the swing and slide operation.
2. Automatic closing and safety features disclosed in co-pending application nos. 2004231234, 2005201187 and 2005903610 are relevant and some of these features may be used in combination with this invention.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

1-8. (canceled)

9. A security safe of the swing and slide type having a pair of door hinges fixed to the door, a pair of frame hinges fixed to the frame and a pair of intermediate hinges fixed to both the door hinges and the frame hinges by links so that the hinges axes are all mutually parallel and the links allow the displacement of the door hinge to lie outside the plane of the door opening when the door is opened through 180.

10. A safe as claimed in claim 9, wherein the door hinges are connected to the intermediate hinges by a first link which permits the slide motion of the door.

11. A safe as claimed in claim 9, wherein the frame hinges are connected to the intermediate hinges by a second link.

12. A safe as claimed in claim 11, wherein the second link is longer than the first link in order to give greater throw.

13. A safe as claimed in claim 12, wherein the second link is a bar or angle member of sufficient width to space the door face from the body of the safe to permit the desired angle of swing.

14. A safe as claimed in claim 13, wherein the width is 50-70 mm.

15. A safe as claimed in claim 13, wherein the slide motion is imparted by a rotary handle and a reaction rod which acts against the second link.
